(19) United States
(12) Patent Application Publication
(10) Pub. No.: US 2024/0096201 A1
(43) Pub. Date: Mar. 21, 2024

(54) Emergency Call Capable System

(71) Applicant: Essence SmartCare Ltd., Herzlia Pituach (IL)

(72) Inventors: Ronel HEMLI, Givat Shmuel (IL); Alon Yechezkel BIRAN, Tel Aviv-Jaffa (IL); Harry LEIB, Petach Tikva (IL)

(21) Appl. No.: 18/522,066

(22) Filed: Nov. 28, 2023

Related U.S. Application Data
(63) Continuation-in-part of application No. PCT/IL2022/050563, filed on May 26, 2022.

(30) Foreign Application Priority Data
May 28, 2021 (US) 63194386

(51) Int. Cl. G08B 25/01; G08B 29/18; H04M 3/424

(52) U.S. Cl. CPC G08B 25/016; G08B 29/185; H04M 3/424; H04M 2242/04

(57) ABSTRACT

An emergency call capable system is disclosed. The system comprises a processing means configured to: instruct a communications apparatus to initiate a call to a remote system in response to a trigger event; determine whether the call satisfies a condition comprising at least one of: (a) the call passes a call duration test; and (b) that data transferred from the remote system after initiating the call passes a human voice test; and instruct the communications apparatus to initiate a further call to the remote system in response to failing to satisfy the condition. Also disclosed is a computer-implemented method of operating an emergency call capable system.

### RELATED APPLICATION/S

This application is a continuation-in-part and claims priority to PCT application number PCT/IL2022/050563 filed on May 26, 2022, and also claims the benefit of priority of U.S. patent application Ser. No. 63/194,386 filed on 28 May 2021, both of which are incorporated herein by reference in their entirety.

### FIELD OF DISCLOSURE

The present disclosure relates in some aspects to an emergency call capable system, and to a computer-implemented method of operating an emergency call capable system.

### BACKGROUND

Emergency call capable systems may be implemented in a variety of different types of premises and for a range of purposes. For example, intruder alarm systems may be capable of initiating emergency calls to alert a third party, such as an operator at an Alarm Receiving Center, to an event such as the triggering of an intruder alarm at monitored premises.

In another example, monitoring systems including environmental sensors to detect a threatening environmental condition such a fire may be emergency call capable systems, capable of directly or indirectly alerting emergency services in the event of an emergency.

In yet another example, an emergency call capable system may be implemented to monitor a person(s), e.g. for their care. Some such systems may monitor the person while they are on a premises, such as independent-living facilities for the elderly, and may use a premises-installed control hub to do so. Systems comprising a portable device may, in some implementations, be used to monitor the person when they are at any location, which may be remote from such a premises. The monitoring may be to provide a response in the event of a threat (actual or perceived) to a person's safety and/or health. The systems may include one or more devices that may include fall detection and/or a distress detection, e.g. by button, pull cord and/or voice command, and may be configured to trigger an emergency call in response to detection of a fall or distress event. Such devices may be installed in the premises and/or carried and/or worn by a person, the latter example being provided by a Personal Emergency Response System (PERS) device.

Emergency call attempts by such emergency call capable systems may fail for a variety of reasons, such as for example: an internal failure in a modem; a network failure; an error at the receiver side, such as at a monitoring station for the emergency call; a human error at the receiver side.

In at least some of the aforementioned examples, the emergency call capable system may not be able to determine that the call was unsuccessful or terminated due to an error. As such, in some instances, the call attempt may complete without attempting a retry and therefore an emergency may not be correctly handled.

Furthermore, in some instances the emergency calls may be to an Alarm Receiving Center (ARC) comprising a call center. As such, responsibility for handling an emergency call may be, to at least some extent, transferred to the call center. It therefore cannot always be guaranteed that a receiver of the emergency call, e.g. an operator at the call center, handles the call in an appropriate or predefined manner and/or reliably provides an indication of successful completion of the call. In some implementations, it may be understood by the ARC and the provider of the emergency call capable system that the latter party (i.e. the provider of the calling system) is responsible only up until the point of making a phone call. In some implementations the latter party may also be responsible up until a notification in respect of the emergency event is transmitted to the ARC and/or an acknowledgement of such a notification is received in return. However, if despite these obligations having been fulfilled, the call is unsuccessfully answered, it may be that a response to the emergency event could fail, be stunted, or made more difficult to handle, at least by the ARC.

It is therefore an aim of the present disclosure to obviate or at least mitigate at least one of the above or other shortcomings of the prior art or provide a useful alternative in the marketplace.

Reference to any prior art in this specification is not an acknowledgement or suggestion that this prior art forms part of the common general knowledge in any jurisdiction, or globally, or that this prior art could reasonably be expected to be understood, regarded as relevant/or combined with other pieces of prior art by a person skilled in the art.

### SUMMARY

According to a first aspect of the disclosure, there is provided an emergency call capable system comprising:
a processing means configured to:
   instruct a communications apparatus to initiate a call to a remote system in response to a trigger event;
   determine whether the call satisfies a condition comprising at least one of: (a) the call passes a call duration test; and (b) that data transferred from the remote system after initiating the call passes a human voice test; and
   instruct the communications apparatus to initiate a further call to the remote system in response to failing to satisfy the condition.

Advantageously, by basing a determination of whether the call satisfies a condition of passing a human voice test, it may be more reliably determined whether a call has been sufficiently handled, and thus whether a retry attempt is required.

Similarly, by alternatively or additionally basing a determination of whether the call satisfies a condition of passing a call duration test, it may be more reliably determined whether a call has been sufficiently handled, and thus whether a retry attempt is required.

That is, in existing emergency call capable systems, call attempts to a remote system may fail for any of a range of reasons, such as for example: an internal failure in the communications apparatus; a network failure between the communications apparatus and the remote system; an error at the remote system; a human error at the remote system.

However, it is not always possible to identify whether any such failures have occurred. For example, when communicating via PSTN, limited signals indicating a success of a call may be available. Furthermore, even if a signal is received indicating a success of a call, this might not mean that the call was picked up by the operator. It may mean, for example, only that the call is established but held at the incoming-call handler (e.g. switchboard), and put on hold without connecting to an operator. This applies also to the case of cellular and IP-based calls.

Thus, the presently disclosed emergency call capable system is advantageous because it can more reliably determine whether a call is successfully made and/or completed to a remote system, and thus more reliably determine whether a further call to the remote system, e.g. a call retry, is necessary.

In some examples, the term “initiate a call” may mean dialing a number, e.g. a telephone number. In some examples, initiating a call may mean making a Voice Over Internet Protocol (VoIP) call.

In some examples, the term “initiate a call” may refer to dialing a phone number or in any other way operating a modem to connect to a phone number. As such, initiating a call may be achieved by calling a phone number, by dialing it or transmitting or issuing instructions by any other means, to connect to the phone number.

The data passing the human voice test may require that at least some of the data defines a human voice.

That is, at least some of the data may correspond to characteristics of a human voice, such as particular frequencies ranges, harmonics and/or patterns of data.

The data passing the human voice test may require that the data correspond to a human voice for at least a minimum amount of the data.

Advantageously, by requiring that data correspond to a human voice for at least a minimum amount of the data, depending on a particular data rate, a threshold minimum duration may be provides. For example, it may be required that a human voice is present in the call for at least a minimum amount of time, which may be defined by the minimum amount of the data.

The data passing the human voice test may require that the data corresponds to a human voice for data corresponding to a minimum amount of time.

In some examples, the minimum amount of time may be an accumulated minimum amount of time, e.g. an accumulated time that may exclude pauses or breaks in speech. In a practical example, an accumulated minimum amount of time allow for a call to be placed on hold, whereby there may be no detectable human voice in data corresponding to a period when the call is on hold.

The condition may further comprise a sub-condition that the call is determined to have been connected for at least a minimum period of time.

In some examples, for a call to have been “connected” the call must have been answered such that voice from the remote device can be transferred to the emergency call capable system.

Passing the human voice test may require identification of a human voice saying at least one predefined keyword.

Passing the human voice test may require identification of a data corresponding to human voice saying at least one predefined keyword.

Passing the human voice test may require identification of a human voice saying a predefined phrase.

Passing the human voice test may require identification of a data corresponding to human voice saying a predefined phrase.

The remote system may be a monitoring station configured to monitor a plurality of emergency call capable systems. For example, the remote system may be a monitoring station manned by one or more human operators. In some examples, the remote system may be an Alarm Receiving Center (ARC).

The emergency call capable system may be pre-configured (i.e. before the trigger event) to initiate the call to the ARC. As such, the emergency call capable system may be a telehealth, telemedicine, telecare, or security device or system, or a combination thereof. This is generally an application specific device, e.g. a health and/or care monitoring device or a control panel for use therewith.

The call and the further call may be over a Public Switched Telephone Network (PSTN), or a cellular network or may be an IP-based call, which may optionally be over a wireless and/or wired network.

The call and the further call may be to a same number. The number may be read from a memory of the emergency call capable system.

The emergency call capable system may comprise the communications apparatus.

The communications apparatus may comprises one or more of: a cellular modem; a PSTN modem; an Ethernet modem; and/or a modem configured to use a protocol based on IEEE 802.11.

The processing means may be configured to monitor communications between an audio codec and the communications apparatus, e.g. a modem.

The processing means may be configured to process said communications for the determining of whether data transferred from the remote system corresponds to a human voice.

The occurrence of a trigger event may be determined based on a signal received from at least one device selected from a group consisting of: a motion sensor; a camera; a health and/or care monitoring device; a fall detector; and/or a distress device.

The motion sensor may be a passive infrared (PIR) motion sensor.

The health and/or care monitoring device comprise at least one of: a heart rate monitoring device; a breathing rate monitoring device; a pulse oximeter; a fall detector; a distress device, such as a distress button, a pull cord distress device and/or voice activated distress device.

In some embodiments, the occurrence of a trigger event may be determined based on a signal received from a fall detector and/or distress device, and/or a voice activated distress device. In some embodiments, the occurrence of a trigger event may additionally or alternatively be determined based on a signal received from a plurality of motion sensors.

The emergency call capable system may comprise a control hub.

The control hub may be configured to wirelessly communicate with one or more devices.

The one or more devices may comprise at least one: PIR motion detector; camera; health and/or care monitoring devices, e.g. heart rate/breathing rate, fall detectors, distress buttons/pull cords.

The one or more devices may comprise said at least one device.

The emergency call capable system may comprise at least one voice-extender module. The emergency call capable system may comprise at least one Voice Panic Detector (VPD), which is a device that makes an emergency call in response to detecting distress in a human voice, e.g. based on voice recognition of predetermined words or phrases sensed by a microphone. The VPD may also have voice-extender functionality. As such, references made herein to a voice-extender module will be understood to additionally or alternatively refer to a VPD.

The at least one voice-extender module may enable two-way audio communications with the control hub.

The at least one voice-extender module may be communicably coupled to the control hub.

The at least one voice-extender module may comprise digital signal processing circuitry configured to execute at least one voice recognition algorithm for identifying at least one of: a distress sound; a word voiced by a person; and/or a phrase voiced by a person, and based on an identification of the distress sound, word and/or phrase, send a signal to the control hub to indicate occurrence of the trigger event.

The voice test may also require identification of voice in the data sent to the remote device. Advantageously, this would provide an indication that a two-way dialogue has occurred.

The processing means may be configured to detect one or more Dual Tone Multi Frequency (DTMF) signals in the data transferred from the remote system.

The condition may comprise a sub-condition that a DTMF signal is detected. For example, in some embodiments, the sub-condition may be that a DTMF, such as DTMF#9, is asserted by the operator to indicated proper completion of the call.

The emergency call capable system may comprise a server.

The communications apparatus may be configured to transfer data corresponding to the trigger event, and/or call metadata, to the server.

Advantageously, an operator handling a call from the emergency call capable system may be provided with information associated with the call on a display, the information based upon the data and/or call metadata.

The communications apparatus may be configured to initiate the call at the server.

The system may comprise a Personal Emergency Response System (PERS) device. For example, the PERS device may be a wearable device such as a pendant or watch.

The emergency call capable system may comprise a trigger device.

To provide the trigger event the trigger device may comprise one or more of: a panic switch; a wearable emergency pendant; a fall detector.

The call to the remote system may be over a PSTN, or a cellular network or may be an IP-based call, which may optionally be over a wireless and/or wired network.

In response to the trigger event the processing means may be further configured to instruct a communications apparatus to transmit a notification of the trigger event to an application server associated with the remote system.

In some examples, the notification of the trigger event may be made via the PSTN to the same location, e.g. the same phone number, as the call is made to.

In some examples, such as when the notification of the trigger event is made via Ethernet or cellular communication means, the notification may be directed to a different location, e.g. a separate application server.

Initiating the call to a remote system may comprise transmitting, to a network, instructions to connect the emergency call capable system to a phone number associated with the remote system.

In examples wherein the call to the remote system is over a PSTN, the same communication apparatus may be used to transmit the notification of the trigger event and make the call.

In examples wherein the call to the remote system is not over a PSTN, e.g. when the call is made using Ethernet or cellular communication means, the same or a different communication apparatus may be used to transmit the notification of the trigger event and make the call.

Transmitting the notification of the trigger event may comprise initiating a first call to the remote system by transmitting signals over a phone line established by the first call.

The call may be said first call. In some examples, when the call the said first call the application server, upon receiving the notification of the trigger event, forwards the call to a call center of the remote system in response.

Said first call may precede said call.

Initiating said call may be in response to the emergency call capable system receiving signals from the remote system indicating acceptance, by the remote system, of the notification.

In another example, in response to the trigger event, the processing means may be further configured to instruct a communications apparatus to transmit a notification of the trigger event to an application server associated with the remote system, wherein initiating the call to a remote system may comprise transmitting, to a network, instructions to connect the emergency call capable system to a phone number associated with the remote system, wherein the notification comprises a network address of the application server.

In some examples, the network address of the application server may be an Internet Protocol (IP) address.

Transmission of the notification may be triggered by identifying occurrence of the trigger event and the initiating of the call may be in response to receipt of a reply from the application server.

Said call and said further call may be to the same phone number.

Said call and said further call may be to different respective phone numbers.

The condition may comprise that data transferred from the remote system after initiating the call passes the human voice test.

The processing means may be configured to determine the whether the call has a duration lasting at least as long as a predefined minimum and in an event that the duration is determine to last at least as long as the predefined minimum, determine that the call duration test is passed.

In some examples, the predefined minimum may be configured according to a sum of:
1. A previously determined parameter corresponding to an average time of the remote system, e.g. an ARC, to answer a call;
2. A previously determined parameter corresponding to a minimum call time by personnel of the remote system, e.g. in the region of 10 seconds; and
3. A previously determined parameter corresponding to an average connection and disconnection time of the communication apparatus, e.g. approximately 2 to 7 seconds for a PSTN modem, potentially less for non-PSTN (e.g. cellular or IP-based) interface.

In an example, the predefined minimum may correspond to a value in the range of 20 to 40 seconds, which may more narrowly be 25 to 35 seconds, or more narrowly approximately or exactly 30 seconds.

The call may be determined to be commenced upon completion of transmitting, to a network, instructions to connect the emergency call capable system to a phone number associated with the remote system, e.g. dialing a number on a PSTN or cellular network, or making a VOIP call over a data network (e.g. internet) comprised of wireless and/or wired infrastructure.

The processing system may be further configured to determine that, upon receiving a signal indicative of completion of the call, the call has been ended.

The signal indicative of completion of the call may comprise a DTMF tone or a line-busy signal.

The condition may comprise that the call passes the call duration test.

According to a second aspect of the disclosure, there is provided a computer-implemented method of operating an emergency call capable system, the method comprising:
instructing a communications apparatus to initiate a call to a remote system in response to a trigger event;
determining whether the call satisfies a condition comprising that data transferred from the remote system after initiating the call passes a human voice test; and
instructing the communications apparatus to initiate a further call to the remote system in response to failing to satisfy the condition.

The data passing the human voice test may require that at least some of the data defines a human voice.

The data passing the human voice test may require that the data corresponds to a human voice for at least a minimum amount of the data.

The data passing the human voice test may require that the data corresponds to a human voice for data corresponding to a minimum amount of time.

The condition may further comprise a sub-condition that the call is determined to have been connected for at least a minimum period of time.

Passing the human voice test may require identification of a human voice saying at least one predefined keyword.

Passing the human voice test may require identification of a human voice saying a predefined phrase.

The remote system may be a monitoring station configured to monitor a plurality of emergency call capable systems.

The call and the further call may be over a PSTN or a cellular network or may be an IP-based call.

The call and the further call may be to a same number. The number may be read from a memory of the emergency call capable system.

The computer-implemented method may comprise monitoring communications between an audio codec and the communications apparatus. The computer-implemented method may comprise processing said communications to determine whether data transferred from the remote system corresponds to a human voice.

The occurrence of a trigger event may be determined based on a signal received from at least one device selected from a group consisting of: a motion sensor; a camera; a health and/or monitoring device; a fall detector; and/or a distress device.

The computer-implemented method may comprise configuring a control hub to wirelessly communicate with one or more devices. The one or more devices may comprise said at least one device.

The computer-implemented method may comprise configuring at least one voice-extender module communicably coupled to the control hub and comprising digital signal processing circuitry to execute at least one voice recognition algorithm for identifying a distress sound, word or phrase voiced by a person, and based on an identification of the distress sound, word or phrase sending a signal to the control hub to indicate occurrence of the trigger event.

The computer-implemented method may comprise detecting one or more Dual Tone Multi Frequency (DTMF) signals in the data transferred from the remote system.

The computer-implemented method may comprise configuring the communications apparatus to transfer data corresponding to the trigger event, and/or call metadata, to the server.

The computer-implemented method may comprise configuring the communications apparatus to initiate the call at the server

The call to the remote system may be over a PSTN or a cellular network or may be an IP-based call.

The computer-implemented method may comprise providing a trigger event to a trigger device comprising one or more of: a panic switch; a wearable emergency pendant; a fall detector.

The computer-implemented method may comprise configuring the processing means, in response to the trigger event, to instruct the communications apparatus to transmit a notification of the trigger event to an application server associated with the remote system, wherein initiating the call to a remote system comprises transmitting, to a network, instructions to connect the emergency call capable system to a phone number associated with the remote system.

Transmitting the notification of the trigger event may comprise initiating a first call to the remote system by transmitting signals over a phone line established by the first call.

Said call may be said first call.

Said first call may precede said call.

Said call may be in response to the emergency call capable system receiving signals from the remote system indicating acceptance, by the remote system, of the notification.

In response to the trigger event the processing means may be further configured to instruct a communications apparatus to transmit a notification of the trigger event to an application server associated with the remote system, wherein initiating the call to a remote system comprises transmitting, to a network, instructions to connect the emergency call capable system to a phone number associated with the remote system, wherein the notification comprises a network address of the application server.

Transmission of the notification may be triggered by identifying occurrence of the trigger event and the initiating of the call is in in response to receipt of a reply from the application server.

Said call and said further call may be to the same phone number.

Said call and said further call may be to different respective phone numbers.

The condition may comprise that data transferred from the remote system after initiating the call passes the human voice test.

The processing means may be configured to determine the whether the call has a duration lasting at least as long as a predefined minimum and in an event that the duration is determine to last at least as long as the predefined minimum, determine that the call duration test is passed.

The call may be commenced upon completion of transmitting, to a network, instructions to connect the emergency call capable system to a phone number associated with the remote system.

The processing means may be further configured to determine that, upon receiving a signal indicative of completion of the call, the call has been ended.

The signal indicative of completion of the call may comprise a DTMF tone or a line-busy signal.

The condition may comprise that the call passes the call duration test.

According to a third aspect of the disclosure, there is provided a computer program product comprising instructions which, when the program is executed by a computer, cause the computer to carry out the method according to the second aspect.

The computer program product may be configured to be executed by a processor in a control hub for an emergency call capable system.

In an embodiment, the computer program product is embodied in a non-transitory computer-readable medium. For example, the computer program product may comprise a memory of a computer that stores the instructions. In another example, the computer program product may comprise a memory of a control hub for an emergency call capable system that stores the instructions.

The above summary is intended to be merely exemplary and non-limiting. The disclosure includes one or more corresponding aspects, embodiments or features in isolation or in various combinations whether or not specifically stated (including claimed) in that combination or in isolation. It should be understood that features defined above in accordance with any aspect of the present disclosure or below relating to any specific embodiment of the disclosure may be utilized, either alone or in combination with any other defined feature, in any other aspect or embodiment or to form a further aspect or embodiment of the disclosure.

### BRIEF DESCRIPTION OF THE SEVERAL VIEWS OF THE DRAWINGS

These and other aspects of the present disclosure will now be described, by way of example only, with reference to the accompanying drawings, wherein:

FIG. 1 depicts a system including an ARC and an emergency call capable system according to an embodiment of the disclosure;

FIG. 2 depicts a circuit for coupling a microcontroller to an interface between a codec and a modem;

FIG. 3 depicts a method of operating an emergency call capable system according to an embodiment of the disclosure; and

FIG. 4 depicts a flow diagram of software corresponding to operation of an emergency call capable system configured to perform the call duration test, according to an embodiment of the disclosure;

FIG. 5 depicts a sequence diagram corresponding to operation of an emergency call capable system, according to an embodiment of the disclosure;

FIG. 6 depicts a sequence diagram corresponding to operation of an emergency call capable system, according to an embodiment of the disclosure; and

FIG. 7 depicts a sequence diagram corresponding to operation of an emergency call capable system, according to an embodiment of the disclosure.

### DETAILED DESCRIPTION OF THE PREFERRED EMBODIMENTS

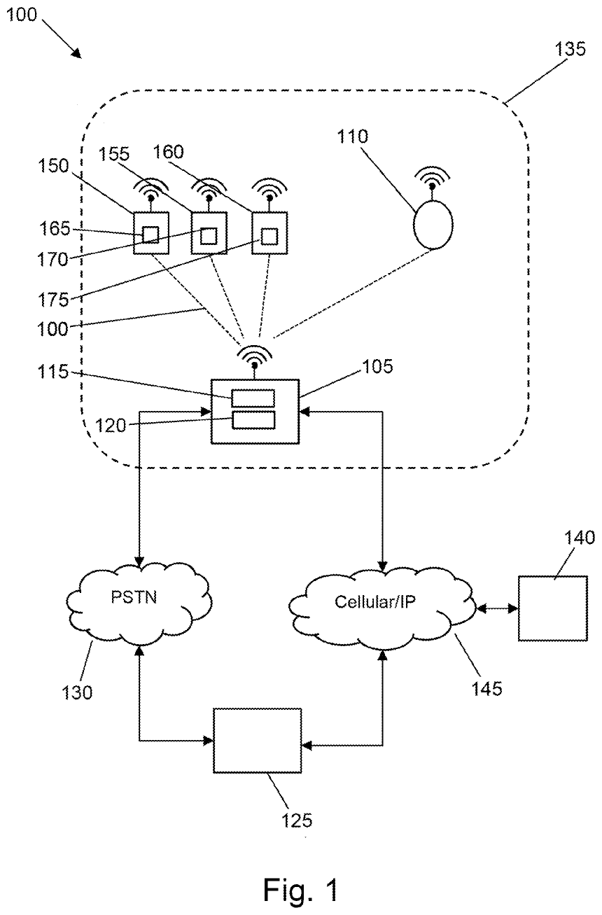

FIG. 1 depicts an example of an emergency call capable system, generally denoted 100. The example system 100 is an emergency call capable system for monitoring at least one person, e.g. for their care. In this example the system includes components installed on a premises at which they reside, such as independent-living facilities for the elderly. However, in other embodiments the system may not be bound to any premises. Further, it will be understood that this embodiment is provided for purposes of example only, and the other emergency call capable systems for different purposes may fall within the scope of the disclosure. For example, in other embodiments the emergency call capable system 100 may additionally or alternatively comprise an intruder alarm system capable of initiating emergency calls in response to a detected security threat. In yet further embodiments, the emergency call capable system 100 may additionally or alternatively comprise a monitoring system including environmental sensors to detect a threatening environmental condition such a fire, flood, chemical leak or the like, wherein the emergency call capable system is capable of directly or indirectly alerting emergency services in the event of an emergency. In any case, the emergency call may be to a third party, e.g. an operator at an Alarm Receiving Center, to enable a conversation in relation to an event that triggered the call.

The system 100 of FIG. 1 comprises a control hub 105. The control hub is communicably coupled to a trigger device 110. Although only one trigger device 110 is depicted in FIG. 1, it will be understood that in other embodiments a plurality of trigger devices may be implemented, wherein each trigger device is communicably coupled to the control hub 105.

For purposes of example only, the trigger device 110 may comprise a sensor for detecting a distress state and/or fall detector (e.g. based on an accelerometer in the case of worn devices, or based on an active reflected wave range measuring device, e.g. a 2D or 3D radar or other multidimensional sensor, for wall mounted devices). In other examples, triggers may additionally or alternatively be in relation to one or more monitored physiological parameters, e.g. vital signs. In some embodiments, a plurality of different trigger devices may be coupled to the control hub 105.

As denoted by the dashed line in FIG. 1, the trigger device 110 is wirelessly coupled to the control hub 105 by, for example, a low power RF connection based on a local (e.g. short range) communications protocol.

The control hub 105 is located at premises 135. In the example of FIG. 1 the trigger device 110 is proximate to the control hub, e.g. within the same premises 135.

In use, the trigger device 110 may provide a signal corresponding to a trigger event to the control hub 105.

The control hub 105 comprises processing means 115. Although in the embodiment depicted in FIG. 1 the processing means 115 is disposed within the control hub 105, in other embodiments some of the processing means 115 may be remote from the control hub 105. For example, some of the processing means 115 may be a remote server or cloud-based or distributed processor.

In the example embodiment of FIG. 1, the processing means 115 comprises at least one processor.

The control hub 105 comprises a communications apparatus 120, such as a modem. In an example embodiment, the communications apparatus 120 is a modem configured for communication over a Public Switched Telephone Network (PSTN). In other example embodiments, the communications apparatus 120 may comprise a cellular modem, an Ethernet modem and/or a modem configured to use a protocol based on IEEE 802.11.

Also depicted in FIG. 1 is a remote system 125. The remote system may be an Alarm Receiving Center, typically having human operators for answering calls, e.g. telephone call made over a PSTN and/or any other network, in an emergency that may be indicated by the control hub 105.

In some embodiments falling within the scope of the disclosure, a control hub may not be implemented, and the trigger device may be configured to communicate using a wide area network address, using Ethernet or Wi-Fi (e.g. using VOIP) or a cellular communication. For example, the trigger device may be a Mobile Personal Emergency Response System (mPERS) device configured to communicate using cellular communications.

The remote system 125 may comprise one or more communications apparatuses for receiving a call over the PSTN or other network, e.g. telephones.

The processing means 115 is configured to instruct the communications apparatus 120 in the control hub 105 to initiate a call to the remote system 125 in response to a trigger event from the trigger device 110. Initiating a call may mean dialing a number, e.g. a telephone number over the PSTN. In some other embodiments, initiating the call may refer to making a VoIP call.

Furthermore, the processing means 115 is configured to determine whether the call satisfies a condition comprising that data transferred from the remote system 125 after initiating the call passes a human voice test.

The processing means 115 is also configured to instruct the communications apparatus 120 in the control hub 105 to initiate a further call to the remote system 125 in response to failing to satisfy the condition.

The data passing the human voice test may require that at least some of the data defines a human voice, e.g. at least some of the data corresponds to characteristics of a human voice, such as particular frequencies ranges. The data passing the human voice test may require that the data correspond to a human voice for at least a minimum amount of the data.

In some examples, the minimum amount of time may be an accumulated minimum amount of time, e.g. an accumulated time that may exclude pauses or breaks in speech. In a practical example, an accumulated minimum amount of time allow for a call to be placed on hold, whereby there may be no detectable human voice in data corresponding to a period when the call is on hold.

The call and the further call may be to a same number, e.g. telephone number. In some examples, the number may be read from a memory of the control hub 105. In other examples, the control hub 105 may be configured to access the number from a remote device, such as a remote server.

The example system 100 also comprises a server 140. The control hub 105 may be configured to communicate with the server 140 over a cellular or IP network 145. For example, the control hub 105 may be configured to communicate with the server 140 over a cellular network using a cellular standard, GSM, 3G, 4G, LTE, 5G, or another standard. As will be appreciated such an IP network may utilize cellular or otherwise wireless infrastructure and/or wired infrastructure. Thus network 145 may optionally comprise different networks for cellular and VOIP call, which optionally may at least partially overlap.

The control hub 105 may be additionally or alternatively configured to communicate with the server 140 over an Internet Protocol (IP) network, such as via an Ethernet LAN, or a ‘Wi-Fi’ connection using a protocol based on IEEE 802.11.

The communications apparatus 120 may be configured to transfer data corresponding to the trigger event, and/or call metadata, to the server 140. The server 140 may provide such data to the remote system 125, such that an operator handling a call from control hub 105 may be provided with information associated with the call on a display, the information based upon the data and/or call metadata.

In some embodiments, the communications apparatus 120 may be configured to initiate the call at the server 140 or at another server such as a dedicated voice server. For example, the server 140 or other server may be configured to establish a call between the control hub 105 and the remote system 125 over either the PSTN network 130 or a cellular or IP network 145.

The processing means 115 may be configured to monitor communications between an audio codec (not shown in FIG. 1) and the communications apparatus 120. In order to determine whether the call satisfies a condition comprising that data transferred from the remote system 125 after initiating the call passes a human voice test, complex digital signal processing (DSP) capabilities may be employed.

In some embodiments, the processing means 115 comprises a microcontroller that receives data from the communications apparatus 20, e.g. a PSTN or LTE modem, e.g. via a Serial Peripheral Interface (SPI). The microcontroller may comprise an audio codec (not shown) for interfacing with a microphone and speaker to enable two-way communication between the caller and the callee. The processing means 115 may thus be comprised entirely in a control hub 105, for example. Further, by having the codec in the control hub, the caller can speak into, and receive reply audio from, the control hub itself, when communicating with the callee.

Further, as will be understood a modem as referred to herein need not be a discrete/separate component—for example it may be provided by a software module in a processor (e.g. a CPU) that also provides the functionality of the microcontroller 205.

In another example, the functions of such a microcontroller may optionally be distributed between a control hub, which comprises the modem, and voice-extender device, such as a VPD, which may comprise the codec.

In particular, in some emergency call capable systems, one or more voice-extender modules may be implemented. Such voice-extender modules are known to be implemented in emergency call capable systems to provide two-way audio communications with a control hub.

For purposes of example only, the system 100 of FIG. 1 depicts three voice-extender modules 150, 155, 160 communicably coupled to the control hub 105. Each voice-extender modules 150, 155, 160 comprises respective DSP circuitry 165, 170, 175.

In an example embodiment of the invention, the digital signal processing circuitry 165, 170, 175 or each voice-extender module 150, 155, 160 may be configured to execute at least one voice recognition algorithm for identifying at least one of: a distress sound; a specified word or phrase voiced by a person (e.g. “help”, “call 911”, or “I've fallen”), and based on an identification of the distress sound, word and/or phrase, send a signal to the control hub 105 to indicate occurrence of the trigger event. Further, the at least one voice recognition algorithm may additionally be configured to identify any speech indicative of an unsuccessful call, e.g. speech stating “the line is busy”, “call back later”, “the destination is not available” or representing any other predefined error message.

Since the voice-extender module 150, 155, 160 already has DSP circuitry 165, 170, 175 for analyzing the human voice to identify a distress call, advantageously the same DSP circuitry may be used to perform one or both of the human voice test and the call duration test as referred to herein.

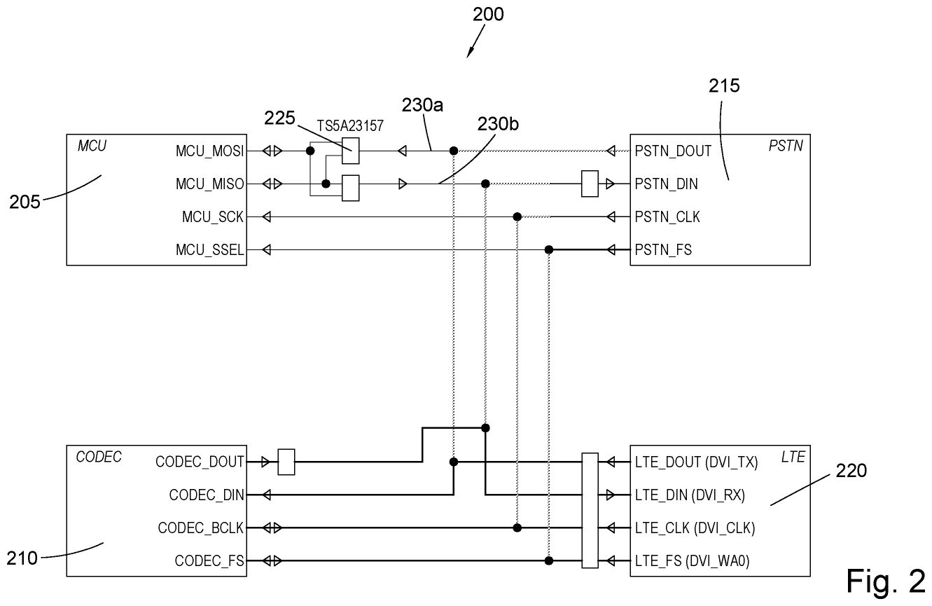

In another example, a control hub may comprise both the modem and the codec and a separate microcontroller. In such an example, data may be shared between the modem and the codec and such data may not be routed via the microcontroller. For such an arrangement, a sniffer circuit may be included to enable the microcontroller to determine what data is coming from and/or to the modem to enable the microcontroller to perform the human voice test and/or call duration test. FIG. 2, depicts an example circuit 200 in accordance with such an arrangement. In particular, FIG. 2 depicts a circuit 200 for coupling a microcontroller 205 to an interface between a codec 210 and modems 215, 220. The processing means 115 may comprise the circuit 200, for example, where the circuit 200 corresponds to a circuit within the control hub 105 of FIG. 1.

In the example of FIG. 2, a first modem 215 is a PSTN modem. A second modem 220 is an LTE modem. It will be understood that this is provided for purposes of example only, and other control hub configurations may comprise fewer than or greater than two modems, wherein any such modem may be configured for communication using different networks, e.g. GSM, 5G, etc.

In the example of FIG. 2, the codec 210 is coupled to the first modem 215 and the second modem 220 by a SPI, although in other embodiments, other interfaces may be implemented.

The sniffer circuit may be implemented enable the microcontroller 205 to monitor audio lines 230a, 230b between the codec 210 and the modems 215, 220, e.g., MOSI and MISO SPI lines carrying data corresponding to audio.

For example, an analog switch 225, such as Texas Instruments Part TS5A23157, may be implemented to allow the microcontroller 205 to be coupled to the audio lines 230a, 230b without interfering with data transmission on said audio lines 230a, 230b. Furthermore, in some examples, the MISO/MOSI signals of the microcontroller 205 may be configured as input-only signals, thus further avoiding any interference being introduced by the microcontroller 205 into data transmitted on the audio lines 230a, 230b.

By implementing such a sniffer circuit, the microcontroller 205 may be able to analyze audio data transferred between the codec 210 and the modems 215, 220, and thereby determine whether the call satisfies a condition comprising that data transferred from the remote system 125 after initiating the call passes a human voice test and/or passes a call duration test.

For example, by monitoring audio line 230a, any signals received from the remote system 125 may be analyzed to determine whether a person has actually attended to the call and/or that the call has lasted for a predefined minimum amount of time. It may be concluded that the call is successful based on an analysis of speech represented such signals received from the remote system 125. For an identification of phrases like “are you ok”, “what is your name” or any other question may be determined to be indicative that the call was answered and is being attended to. This may be taken to be indicative of a successful call. On the other hand, phrases representing an error message may be taken as indicating that the call was unsuccessful.

Additionally or alternatively, the controller 205 may also be configured to monitor audio line 230b between the codec 210 and the modems 215, 220 to analyze audio data transferred between the codec 210 and the modems 215, 220, and thereby determine whether a caller is speaking. This may be used, for example, to validate that the person at risk has responded to certain prompts from a call recipient, and thus by implication confirm that the call has been answered and attended to. This may be used as a supplement to the human voice test.

However, as will be appreciated from the description above, it is particularly advantageous to monitor at least the line 230a received from the remote system 230 as signals from, as opposed to towards, the remote system 230 can provide a more informative indicator of a call having been successfully attended to.

The digital signal processing circuitry 165, 170, 175 or each voice-extender module 150, 155, 160 may be configured to execute at least one voice recognition algorithm. Thus, in some embodiments, the control hub 105 may be configured to use processing capabilities of one or more voice-extender modules 150, 155, 160 to analyze the audio data.

In other embodiments, the processing means 115 of the control hub 105 may be capable of such an analysis of the audio data, and thus offloading such processing to a voice-extender module may not be necessary.

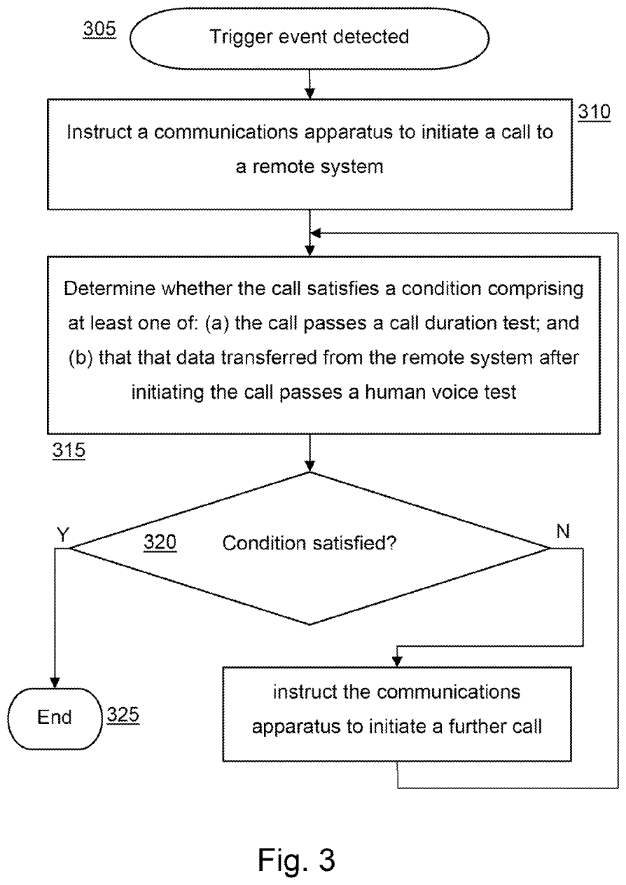

FIG. 3 depicts a method of operating the emergency call capable system 100

At a first step 305, a trigger event is detected. As described above, the trigger event is a trigger event from the trigger device 110.

At a second step 310, the communications apparatus 120 is instructed by the processing means 115 to initiate a call to the remote system 125 in response to the trigger event.

At a third step 315, the processing means 115 makes a determination of whether the call satisfies the condition comprising at least one of: (a) the call passes a call duration test; and (b) that data transferred from the remote system 125 after initiating the call passes the human voice test.

Decision point 320 depends upon the determination made in the third step 315. It the condition is satisfied, e.g. the human voice test is passed, then no reattempt at the call is made, and denoted by a final step 325 indication an end of to the method.

However, if the condition is not satisfied at decision point 320, then the processing means 115 instructs the communications apparatus 120 to initiate a further call. In some embodiments, the further call would be to the same telephone number as the initial call.

It will be appreciated that the flow diagram of FIG. 3 corresponding to the method of operating the emergency call capable system 100 may represent a simplification of the method, and further steps may exist in methods falling within the scope of the disclosure.

For example, although the flow diagram of FIG. 3 depicts a further call being initiated in the event the condition is not satisfied, in some embodiments an amount of attempts at further calls may be limited.

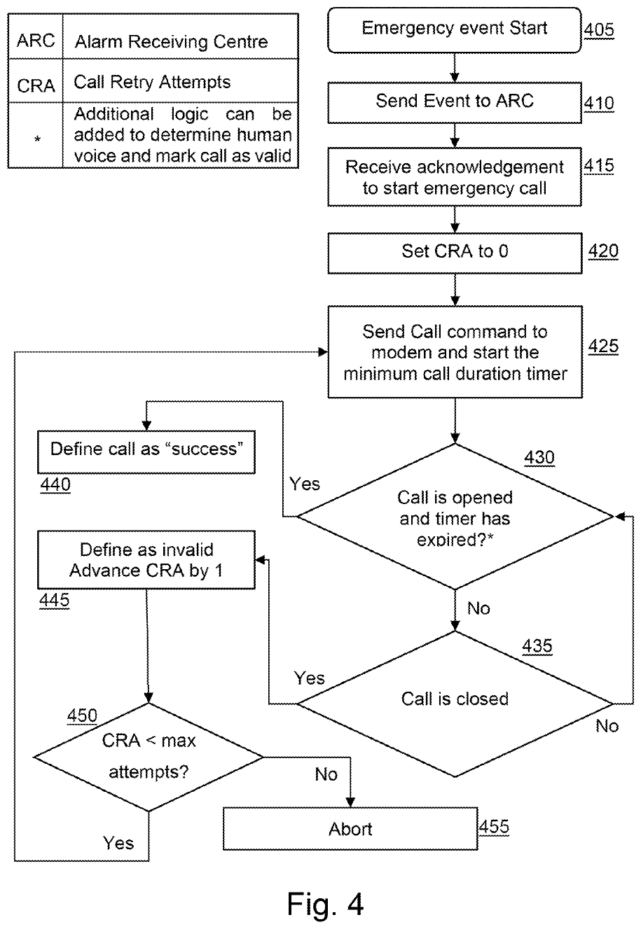

FIG. 4 depicts a flow diagram of software corresponding to operation of an emergency call capable system configured to perform the call duration test, according to an embodiment of the disclosure.

At an initial step 405, an emergency event occurs, e.g. a trigger event.

The occurrence of an emergency event may be determined based on a signal received from a triggering device. For example, such a device may be selected from a group consisting of: a motion sensor; a camera; a health and/or care monitoring device; a fall detector; and/or a distress device. The health and/or care monitoring device comprise at least one of: a heart rate monitoring device; a breathing rate monitoring device; a pulse oximeter; a fall detector; a distress device, such as a distress button, a pull cord distress device and/or voice activated distress device such as a VPD.

At a next step 410, the event is sent to the ARC. That is, in response to the trigger event, processing means executing the software may be configured to instruct a communications apparatus to transmit a notification of the trigger event to an application server associated with a remote system.

At a next step 415 an acknowledgment from the ARC is received indicating an emergency call may be started.

In some embodiments, the acknowledgment from the ARC, e.g. from an application server, may provide one or more phone number of the ARC, e.g. a call center at the ARC.

In some embodiments, the acknowledgment from the ARC, e.g. from an application server, may provide details of an address, such as an internet address, at which a server of the ARC may be accessed.

In some embodiments, the relevant number(s) and/or addresses are already available to the processing means executing the software. For example, the relevant number(s) and/or addresses may be read from a memory of the emergency call capable system.

At a next step 420 a ‘Call Retry Attempts’ parameter, denoted CRA, is reset to a value of zero. CRA provides a running total of a number of attempts at making a call that is closed before a minimum call duration timer has expired, as described in more detail below.

At a next step 425 a call command is sent to a modem and a minimum call duration timer is started.

The call command is used to configure the modem to initiate a call, e.g. dial the relevant number of the ARC, thus effectively starting the call.

At a first decision point 430 a determination is made of whether the call is opened and a timer has expired.

In some examples, a signal may be provided by the ARC, e.g. by the application server, indicating that the call is opened.

Optionally in the case of using a cellular modem, the cellular modem may itself indicate if and when the call is opened. Similarly, any additional or alternative infrastructure used for a VOIP call may indicate when a VOIP call is opened. Such indications may be provided by the layer of the communications protocol that controls the call.

If the call was opened and it was determined that the timer expired, the call is defined as a success at step 440, and the flow ends. In other words, it is assumed that the call lasted for a sufficient duration. The duration may be sufficient by lasting for long enough to be indicative that a person has in fact knowingly answered the call and optionally also long enough to be indicative that the caller is aware of that fact. This is important because it may be agreed between the provider of the emergency call capable system 100 and the ARC that once the emergency call capable system 100 determines that a call has been made (either by assumption upon calling the number, or by confirmation upon receipt of a call-opened signal), responsibility for the call passes from the system 100 to the ARC. However, it is possible that the call could be automatically answered and immediately closed thereafter, without anyone at the ARC being aware of it. As a result, a person at the ARC may not know to call back. In other implementations, the ARC may not be technically able to call back, so the call duration should at least be long enough to provide confidence that critical information is conveyed, e.g. the location and state of the person. In any case, if the call is determined to be of sufficient duration, there is no need for the system 100 to call again.

If, on the other hand, the call was opened and the call is determined to then become closed before the timer has expired, then it is assumed that the call is of insufficient duration. For example, until the timer has expired, it may be monitored as to whether the call is closed, as shown by second decision point 435, whereby if the call is closed before the timer expires the call duration is deemed to have been insufficient. It will be appreciated that the term “second decision point” is intended to mean “another decision point” rather than implying that it occurs after the “first” decision point.

In some examples, where the call is a VOIP call or cellular voice call, when the call is closed, a signal specifically defining that the call is closed may be received. Such a signal may be received from the layer of the communication protocol that controls the call.

In another example, namely where the call is over a PSTN, the call may be determined to be closed upon receipt of a line-busy signal, which should occur when the call is hung up at the call center. Optionally, irrespective of whether such a line-busy signal is received, the call may be determined to be closed upon received of any or a specific DTMF signal. For example, operators at the call center may be trained to dial “9” when they have finished the call.

As will be appreciated, if at the second decision point 435 it is not determined that the call has been closed then the flow reverts to the first decision point 430.

If at the second decision point 435 it is determined that the call has been closed (and the timer is not yet expired) then at a next step 445 the call is defined as invalid, and the parameter CRA is incremented by 1.

In some embodiments, at step 430 the above-described human voice test may be performed. If the human voice test is passed, then the call is defined as a success at step 440, and the flow ends. Thus, if either the human voice test or the call duration test is passed then the call is defined as a success. In other embodiments, it may be required that both the human voice test and the call duration test must be passed for the call to be defined as a success. In yet other embodiments in which passing the human voice test is required for a successful call, there may be no call duration test—in other words at step 430 a human voice test may optionally be employed instead of a call duration test. Regardless of the test(s) employed at step 430, at a third decision point 450 a determination is made as to whether the value of CRA is less than a predefined maximum value. The predefined maximum value may correspond to a maximum allowable number of call retry attempts.

If at the third decision point 450 it is determined that the value of CRA is less than the predefined maximum value, then the emergency call capable system 100 initiates a further call to the ARC. This indicated in FIG. 4 by reverting to step 425.

If at the third decision point 450 it is determined that the value of CRA is not less than the predefined maximum value, then at a final step 455 the emergency call capable system 100 aborts the process, i.e. it makes no further calls to that ARC.

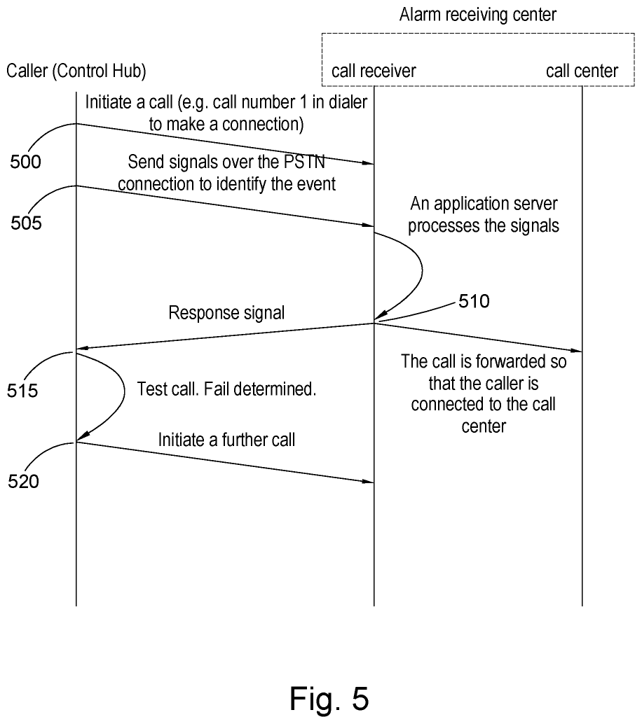

FIG. 5 depicts a sequence diagram corresponding to operation of an emergency call capable system, according to an embodiment of the disclosure.

In a first step 500 a caller, e.g. a control hub, initiates a call to a call receiver. That is, a processing means of an emergency call system is configured to instruct a communications apparatus, in this example a PSTN modem, to initiate a call to a remote system in response to a trigger event. The call receiver is a device capable of receiving the call. In the example of FIG. 5, an ARC is the remote system and the call receiver is at the ARC. The call receiver may comprise an application server. The application server may handle the call by answering it, processing any subsequent PSTN signals received thereafter, determining how to respond to the call and/or subsequent PSTN signals, and performing such a response.

For purposes of example, phone number 1, e.g. a first telephone number, is used to initiate the call.

Initiating a call to the call to the receiver may comprise the processing means configuring a dialer, e.g. a software routine running in the control hub, to control a modem to call a number to make a connection. The processing means may have access to a pre-defined dial sequence which defines a predefined first phone number, and optionally a list of subsequent phone numbers, to be called by the caller. The phone number(s) may, for example, be provided in a software routine or database accessible by software executed in the control hub. Thus, the call initiated at step 500 may be to the first phone number, denoted herein as phone number 1.

In the case of initiation of the call over a PSTN, it is assumed that once the call has been made, e.g. the number dialed, or after a short predefined time from the call being made, that the connection has been made. That is, even if no indication is received from the call receiver, it is assumed that a connection has been made. The short predefined time may be based on a parameter corresponding to an average time of the ARC to answer a call. The short predefined time may, for example, be based on a parameter corresponding to an average connection time of the PSTN modem to a call the receiver.

Once the connection has been made, at a next step 505 signals are sent over the PSTN connection to identify the trigger event. For example, such signals may indicate what the triggering device was and/or information associated with the triggering event. Such signals may provide information such as whether the trigger event relates to a particular event or category of event, e.g., a fall event or panic event. The signals may be DTMF tones. An appropriate protocol may be used for transmitting the signals, for example Contact ID protocols or CIA protocol.

At a next step 510, the application server processes the signals received by the call receiver, and commands transmission of a response signal to the caller, from the call receiver, over the PTSN connection. In some examples, the response signal may merely comprise an acknowledgment. In some examples, the response signal may additionally or alternatively comprise further information. For example, such further information may comprise instructions for the caller. In an example, said instructions may be for the caller to call a particular number, or to hang-up and re-attempt calling (i.e. attempt a further call).

At step 510, the application server may also forward the call such that the caller is connected to a call center, and is thus able to communicate directly with personnel at the call center. That is, in some embodiments the application server may both provide an acknowledgment and/or further information to the caller, in addition to connecting the call made by the caller to the call center.

At step 515, upon receipt of the response signal a determination is made by processing means of the control hub, as to whether the call satisfies a condition comprising at least one of: (a) the call passes a call duration test as described above; and (b) that data transferred from the remote system after initiating the call passes a human voice test, as described above.

If it is determined that the relevant test(s) are failed, then at a subsequent step 520 a further call is initiated.

Depending upon a particular configuration of the control hub, the further call may be to the same phone number, e.g. using phone number 1.

In some embodiments, the further call may be made to a different number, e.g. a second phone number stored in a predefined dial sequence, or in other embodiments provided in the response signal at step 510.

As described above with reference to the flow diagram of FIG. 3, in some embodiments a parameter corresponding to a total of a failed call attempts may be updated at step 520. In some embodiments, a maximum allowable number of call attempts may be defined, e.g. 2 attempts or 3 attempts, corresponding to 1 retry or 2 retries (i.e. 1 or 2 further calls), respectively.

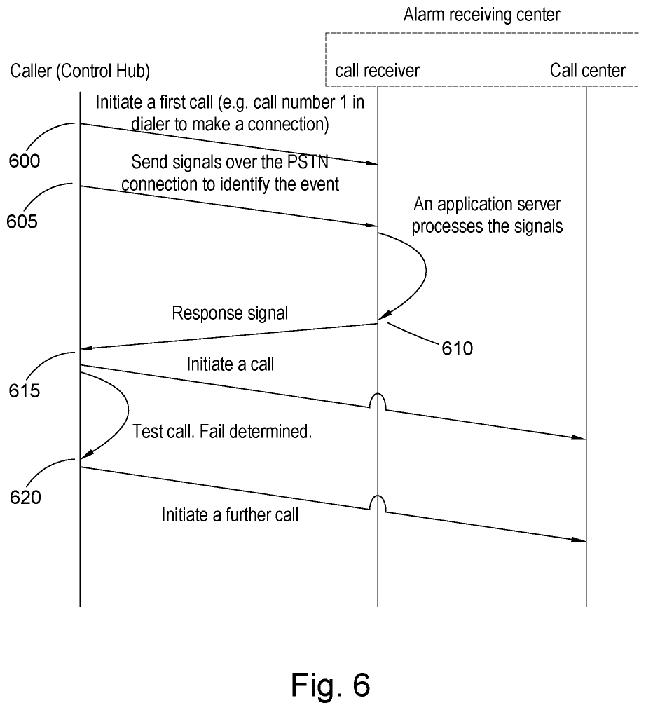

FIG. 6 depicts a sequence diagram corresponding to operation of an emergency call capable system, according to another embodiment of the disclosure.

In a first step 600 a caller, e.g. a control hub, initiates a call to a call receiver, which in this example is the same as step 500. Once the connection has been made, at a next step 605 signals are sent over the PSTN connection to identify the trigger event. In this example, this is the same as step 505.

At a next step 610, the application server processes the signals receiver by the call receiver, and command transmission of a response signal to the caller, from the call receiver, over the PTSN connection. In some examples, the response signal may merely comprise an acknowledgment. In some examples, the response signal may additionally or alternatively comprise further information. For example, such further information may comprise instructions for the caller. In an example, said instructions may be for the caller to call a particular number, or to hang-up and re-attempt calling, as in the case of step 510.

Upon receipt of the response signal, at step 615, the caller initiates a call to the call center, and is thus able to communicate directly with personnel at the call center.

That is, in the example embodiment of FIG. 6, the application server instructs the caller to hang up the first call and directly call the call center.

In some embodiments, at step 615, the caller directly calls the call center using a different number, e.g. a second phone number (phone number “2”) as defined by a predefined dial sequence, or in other embodiments provided in the response signal at step 510.

In yet further embodiments (not depicted), the caller may initiate the call using phone number 1 again, wherein upon receipt of the call the call receiver, e.g. the application server, is configured to forward the call to the call center. That is, the call receiver recognizes the number from the call made at step 600, and this time it automatically forwards the call for receival by an attendant.

Following the initiation of the call at step 615, a determination is made by processing means of the control hub, as to whether the call satisfies a condition comprising at least one of: (a) the call passes a call duration test as described above; and (b) that data transferred from the remote system after initiating the call passes a human voice test, as described above.

If it is determined that the relevant test(s) are failed, then at a subsequent step 620 a further call is initiated.

Depending upon a particular configuration of the control hub, the further call may be to the same number, e.g. using phone number 1.

In some embodiments, the further call may be made to the different number, e.g. a second phone number defined by a dial sequence, or in other embodiments provided in the response signal at step 610.

Again, as described above, a maximum allowable number of call attempts may be defined.

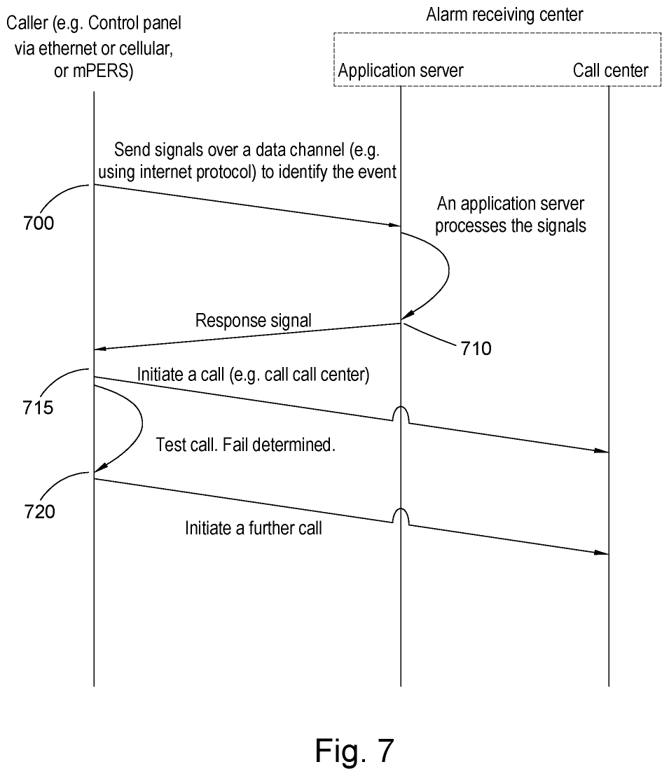

FIG. 7 depicts a sequence diagram corresponding to operation of an emergency call capable system, according to another embodiment of the disclosure.

In contrast to the embodiments of FIGS. 5 and 6 wherein the calls are made over a PSTN, in the example embodiment of FIG. 7 the calls are made using cellular communications means, Ethernet, or using an internet protocol, whether via a cellular modem, Ethernet modem or some other communication modem. Furthermore, in the example of FIG. 7, since a PSTN modem is not used, the implementation of a control hub or other location-installed device is optional. For example, a device, such as an mPERS device, may be configured to communicate directly with an ARC.

In a first step 700 a caller sends data to an application server at an ARC. That is, a processing means of an emergency call system is configured to instruct a communications apparatus, such as for example a cellular communications means in the emergency call capable system, to send data over a data channel to an Alarm Receiving Center in response to a trigger event.

The data sent by the caller may indicate what the triggering device was and/or information associated with the triggering event. Such data may provide information such as whether the trigger event relates to a particular event or category of event, e.g., a fall event, panic event.

At a next step 710, the application server processes the received data and sends a response signal to the caller via the same channel over which the application server received the data sent at step 700. In some examples, the response signal may merely comprise data corresponding to an acknowledgment. In some examples, the response signal may additionally or alternatively comprise data corresponding to further information. For example, such further information may comprise instructions for the caller. In an example, said instructions may be for the caller to call a particular number, or to hang-up and re-attempt calling.

Upon receipt of the response signal, at step 715, the caller initiates a call to the call center, and is thus able to communicate directly with personnel at the call center.

In the example embodiment of FIG. 7, the application server may instruct the caller to directly call the call center.

In some embodiments, at step 715, the caller directly calls the call center using a predefined number. For example, one or more predefined numbers may be stored in a software routine or database accessible by software executed in the calling device, e.g. an mPERS device. In some embodiments, the application server may provide a number for the caller to initiate a call directly with the call center. In yet further embodiments (not depicted), the caller may initiate the call with the application server again, e.g. using a data channel, wherein upon receipt of the call the application server is configured to forward the call to the call center.

Following the initiation of the call at step 715, a determination is made as to whether the call satisfies a condition comprising at least one of: (a) the call passes a call duration test as described above; and (b) that data transferred from the remote system after initiating the call passes a human voice test, as described above.

If it is determined that the relevant test(s) are failed, then at a subsequent step 720 a further call is initiated. The further call may be to the same number or to a different number. Again, as described above, a maximum allowable number of call attempts may be defined.

In each of the example described herein, advantageously, each of the one or more further calls may be made by the caller without again sending the event to the ARC. In other words, though making the further calls the processing means does not instruct the communication apparatus to further transmit notifications of the trigger event. Not transmitting further notifications to the application server has an advantage that the ARC may not be confused into concluding that a further event (e.g. distress button press, fall detection event, etc) has occurred. Thus, each of the further calls are treated by the ARC as being associated with the event for which the notification that was sent at step 505, 605 or 700. By contrast, if the notification sent at step 505, 605 or 700 fails to be acknowledged, the emergency call capable system may optionally operate a different event response action that comprises transmitting a further notification of the trigger event, for example by starting again from step 500, 600 or 700. If executing step 500, 600 or 700 for a second time, it may be to the same remote system or to a different remote system (e.g., another ARC or to a mobile phone of a family member).

It will be understood that the above description is merely provided by way of example, and that the present disclosure may include any feature or combination of features described herein either implicitly or explicitly of any generalization thereof, without limitation to the scope of any definitions set out above. It will further be understood that various modifications may be made within the scope of the disclosure.

Each of following clauses define respective exemplary embodiments of the present invention.
1. An emergency call capable system comprising:
   a processing means configured to:
      instruct a communications apparatus to initiate a call to a remote system in response to a trigger event;
      determine whether the call satisfies a condition comprising at least one of: (a) the call passes a call duration test; and (b) that data transferred from the remote system
   after initiating the call passes a human voice test; and instruct the communications apparatus to initiate a further call to the remote system in response to failing to satisfy the condition.
2. The emergency call capable system of clause 1, wherein the data passing the human voice test requires that at least some of the data defines a human voice.
3. The emergency call capable system of clause 1 or 2, wherein the data passing the human voice test requires that at least one of:
the data corresponds to a human voice for at least a minimum amount of the data; and/or
the data corresponds to a human voice for data corresponding to a minimum amount of time.
4. The emergency call capable system of any preceding clause, wherein the condition further comprises a sub-condition that the call is determined to have been connected for at least a minimum period of time.
5. The emergency call capable system of any preceding clause, wherein passing the human voice test requires identification of at least one of:
   a human voice saying at least one predefined keyword;
   a human voice saying a predefined phrase.
6. The emergency call capable system of any preceding clause, wherein the remote system is a monitoring station configured to monitor a plurality of emergency call capable systems.
7. The emergency call capable system of any preceding clause, wherein the call and the further call is over a Public Switched Telephone Network (PSTN) or cellular network or is a VOIP call.
8. The emergency call capable system of any preceding clause, wherein the call and the further call are to a same number.
9. The emergency call capable system of any preceding clause, comprising the communications apparatus.
10. The emergency call capable system of clause 9, wherein the communications apparatus comprises one or more of: a cellular modem; a PSTN modem; an Ethernet modem; and/or a modem configured to use a protocol based on IEEE 802.11; for example the communications apparatus may comprise a PSTN modem.
11. The emergency call capable system of any preceding clause, wherein the processing means is configured to monitor communications between an audio codec and the communications apparatus, and process said communications for the determining of whether data transferred from the remote system corresponds to a human voice.
12. The emergency call capable system of any preceding clause, wherein the occurrence of a trigger event is determined based on a signal received from at least one device selected from a group consisting of: a motion sensor; a camera; a health and/or care monitoring device; a fall detector; and/or a distress device.
13. The emergency call capable system of clause 12 comprising a control hub configured to wirelessly communicate with one or more devices, the one or more devices comprising said at least one device.
14. The emergency call capable system of clause 13, comprising at least one voice-extender module communicably coupled to the control hub, the at least one voice-extender module comprising digital signal processing circuitry configured to execute at least one voice recognition algorithm for identifying a distress sound, word or phrase voiced by a person, and based on an identification of the distress sound, word or phrase send a signal to the control hub to indicate occurrence of the trigger event.
15. The emergency call capable system of any preceding clause, wherein the processing means is configured to detect one or more Dual Tone Multi Frequency (DTMF) signals in the data transferred from the remote system, and wherein the condition comprises a sub-condition that a DTMF signal is detected.
16. The emergency call capable system of any preceding clause, comprising a server, wherein at least one of:
   the communications apparatus is configured to transfer data corresponding to the trigger event, and/or call metadata, to the server; and/or
   the communications apparatus is configured to initiate the call at the server.
17. The emergency call capable system of any preceding clause, wherein the system comprises a Personal Emergency Response System (PERS) device.
18. The emergency call capable system of clause 17, comprising a trigger device, wherein to provide the trigger event the trigger device comprises one or more of: a panic switch; a wearable emergency pendant; a fall detector.
19. The emergency call capable system of any of any preceding clause, wherein the call to the remote system is over a PSTN or cellular network or is a VOIP call.
20. The emergency call capable system of any preceding clause, wherein in response to the trigger event the processing means is further configured to instruct a communications apparatus to transmit a notification of the trigger event to an application server associated with the remote system, wherein initiating the call to a remote system comprises transmitting, to a network, instructions to connect the emergency call capable system to a phone number associated with the remote system.
21. The emergency call capable system of clause 20, wherein transmitting the notification of the trigger event comprises initiating a first call to the remote system by transmitting signals over a phone line established by the first call.
22. The emergency call capable system of clause 21, wherein said call is said first call.
23. The emergency call capable system of clause 21, wherein said first call precedes said call.
24. The emergency call capable system of clause 23, initiating said call is in response to the emergency call capable system receiving signals from the remote system indicating acceptance, by the remote system, of the notification.
25. The emergency call capable system of any of clauses 1 to 18, wherein in response to the trigger event the processing means is further configured to instruct a communications apparatus to transmit a notification of the trigger event to an application server associated with the remote system, wherein initiating the call to a remote system comprises transmitting, to a network, instructions to connect the emergency call capable system to a phone number associated with the remote system, wherein the notification comprises a network address of the application server.
26. The emergency call capable system of clause 25, wherein transmission of the notification is triggered by identifying occurrence of the trigger event and the initiating of the call is in in response to receipt of a reply from the application server.
27. The emergency call capable system of any preceding clause, wherein said call and said further call are to the same phone number.
28. The emergency call capable system of any clauses 1 to 26, wherein said call and said further call are to different respective phone numbers.
29. An emergency call capable system of clause any preceding clause, wherein the condition comprises that data transferred from the remote system after initiating the call passes the human voice test.
30. An emergency call capable system of any preceding clause, wherein the processing means is configured to determine the whether the call has a duration lasting at least as long as a predefined minimum and in an event that the duration is determine to last at least as long as the predefined minimum, determine that the call duration test is passed.
31. An emergency call capable system of any preceding clause, wherein the call is commenced upon completion of transmitting, to a network, instructions to connect the emergency call capable system to a phone number associated with the remote system.
32. An emergency call capable system of any preceding clause, wherein the processing means is further configured to determine that, upon receiving a signal indicative of completion of the call, the call has been ended; for example, wherein the signal indicative of completion of the call comprises a DTMF tone or a line-busy signal.
33. An emergency call capable system of any preceding clause, wherein the condition comprises that the call passes the call duration test.
34. An emergency call capable system of any preceding clause when appended to clause 20 or 25, wherein in initiating the further call, the processing means does not transmit a further notification of the trigger event to said application server associated with said remote system.
35. A computer-implemented method of operating an emergency call capable system, the method comprising:
   instructing a communications apparatus to initiate a call to a remote system in response to a trigger event;
   determining whether the call satisfies a condition comprising at least one of: (a) the call passes a call duration test; and (b) that data transferred from the remote system after initiating the call passes a human voice test; and
   instructing the communications apparatus to initiate a further call to the remote system in response to failing to satisfy the condition.
36. The computer-implemented method of clause 35, wherein the data passing the human voice test requires that at least some of the data defines a human voice.
37. The computer-implemented method of clause 35 or 36, wherein the data passing the human voice test requires that at least one of:
   the data corresponds to a human voice for at least a minimum amount of the data; and/or a
   the data corresponds to a human voice for data corresponding to a minimum amount of time.
38. The computer-implemented method of any of clauses 35 to 37, wherein the condition further comprises a sub-condition that the call is determined to have been connected for at least a minimum period of time.
39. The computer-implemented method of any of clauses 35 to 38, wherein passing the human voice test requires identification of at least one of:
   a human voice saying at least one predefined keyword;
   a human voice saying a predefined phrase.
40. The computer-implemented method of any of clauses 35 to 39, wherein the remote system is a monitoring station configured to monitor a plurality of emergency call capable systems.
41. The computer-implemented method of any of clauses 35 to 40, wherein the call and the further call is over a PSTN or cellular network or is a VOIP call.
42. The computer-implemented method of any of clauses 35 to 41, wherein the call and the further call are to a same number.
43. The computer-implemented method of any of clauses 35 to 42, comprising monitoring communications between an audio codec and the communications apparatus, and processing said communications to determine whether data transferred from the remote system corresponds to a human voice.
44. The computer-implemented method of any of clauses 35 to 43, wherein the occurrence of a trigger event is determined based on a signal received from at least one device selected from a group consisting of: a motion sensor; a camera; a health and/or care monitoring device; a fall detector; and/or a distress device.
45. The computer-implemented method of clause 44, comprising configuring a control hub to wirelessly communicate with one or more devices, the one or more devices comprising said at least one device.
46. The computer-implemented method of clause 45, comprising configuring at least one voice-extender module communicably coupled to the control hub and comprising digital signal processing circuitry to execute at least one voice recognition algorithm for identifying a distress sound, word or phrase voiced by a person, and based on an identification of the distress sound, word or phrase sending a signal to the control hub to indicate occurrence of the trigger event.
47. The computer-implemented method of any of clauses 35 to 46, comprising detecting one or more Dual Tone Multi Frequency (DTMF) signals in the data transferred from the remote system.
48. The computer-implemented method of any of clauses 35 to 47, comprising:
   configuring the communications apparatus to transfer data corresponding to the trigger event, and/or call metadata, to the server; and/or
   configuring the communications apparatus to initiate the call at the server
49. The computer-implemented method of any of clauses 30 to 48, wherein the call to the remote system is over a PSTN or cellular network or is an VOIP call.
50. The computer-implemented method of any of clauses 35 to 49, comprising providing a trigger event to a trigger device comprising one or more of: a panic switch; a wearable emergency pendant; a fall detector.
51. The computer-implemented method of any of clauses 35 to 50 comprising configuring the processing means, in response to the trigger event, to instruct the communications apparatus to transmit a notification of the trigger event to an application server associated with the remote system, wherein initiating the call to a remote system comprises transmitting, to a network, instructions to connect the emergency call capable system to a phone number associated with the remote system.
52. The computer-implemented method of clause 51, wherein transmitting the notification of the trigger event comprises initiating a first call to the remote system by transmitting signals over a phone line established by the first call.
53. The computer-implemented method of clause 52, wherein said call is said first call.
54. The computer-implemented method of clause 52, wherein said first call precedes said call.
55. The computer-implemented method of clause 54, wherein said call is in response to the emergency call capable system receiving signals from the remote system indicating acceptance, by the remote system, of the notification.
56. The computer-implemented method of any of clauses 35 to 50, wherein in response to the trigger event the processing means is further configured to instruct a communications apparatus to transmit a notification of the trigger event to an application server associated with the remote system, wherein initiating the call to a remote system comprises transmitting, to a network, instructions to connect the emergency call capable system to a phone number associated with the remote system, wherein the notification comprises a network address of the application server.
57. The computer-implemented method of clause 56, wherein transmission of the notification is triggered by identifying occurrence of the trigger event and the initiating of the call is in in response to receipt of a reply from the application server.
58. The computer-implemented method of any of clauses 35 to 57, wherein said call and said further call are to the same phone number.
59. The computer-implemented method of any of clauses 35 to 57, wherein said call and said further call are to different respective phone numbers.
60. The computer-implemented method of any of clauses 35 to 59, wherein the condition comprises that data transferred from the remote system after initiating the call passes the human voice test.
61. The computer-implemented method of any of clauses 35 to 60, wherein the processing means is configured to determine the whether the call has a duration lasting at least as long as a predefined minimum and in an event that the duration is determine to last at least as long as the predefined minimum, determine that the call duration test is passed.
62. The computer-implemented method of any of clauses 35 to 61, wherein the call is commenced upon completion of transmitting, to a network, instructions to connect the emergency call capable system to a phone number associated with the remote system.
63. The computer-implemented method of any of clauses 35 to 62, wherein the processing means is further configured to determine that, upon receiving a signal indicative of completion of the call, the call has been ended; for example, wherein the signal indicative of completion of the call comprises a DTMF tone or a line-busy signal.
64. The computer-implemented method of any of clauses 35 to 63, wherein the condition comprises that the call passes the call duration test.
66. The computer-implemented method of any of any preceding clause when appended to clause 51 or 56, wherein in initiating the further call, the processing means does not transmit a further notification of the trigger event to said application server associated with said remote system.
67. A computer program product comprising instructions which, when the program is executed by a computer, cause the computer to carry out the method of any of clauses 35 to 65 or 71 or 72.
68. The computer program product of clause 67, configured to be executed by a processor in a control hub for an emergency call capable system.
69. The emergency call capable system of any one of clauses 1 to 34, wherein satisfying the condition requires that any speech identified in the data does not indicate that the call was unsuccessful.
70. The emergency call capable system of clause 69, wherein speech identified in the data is determined to indicate that the call was unsuccessful in response to any one of a plurality of predefined error messages being identified in the data.
71. The computer-implemented method of any one of clauses 35 to 66, wherein satisfying the condition requires that any speech identified in the data does not indicate that the call was unsuccessful.
72. The computer-implemented method of clause 71, wherein speech identified in the data is determined to indicate that the call was unsuccessful in response to any one of a plurality of predefined error messages being identified in the data.

What is claimed is:

1. An emergency call capable system comprising:
a processing means configured to:
instruct a communications apparatus to initiate a call to a remote system in response to a trigger event;
determine whether the call satisfies a condition comprising at least one of:
(a) the call passes a call duration test, wherein the condition further comprises a sub-condition that the call is determined to have been connected for at least a minimum period of time; and
(b) that data transferred from the remote system after initiating the call passes a human voice test, wherein the data passing the human voice test requires that at least some of the data defines a human voice; and
instruct the communications apparatus to initiate a further call to the remote system in response to failing to satisfy the condition.

2. The emergency call capable system of claim 1, wherein the condition comprises that data transferred from the remote system after initiating the call passes a human voice test.

3. The emergency call capable system of claim 2, wherein the data passing the human voice test requires that at least one of:
the data corresponds to a human voice for at least a minimum amount of the data; and/or a
the data corresponds to a human voice for data corresponding to a minimum amount of time.

4. The emergency call capable system of claim 2, wherein satisfying the condition requires that any speech identified in the data does not indicate that the call was unsuccessful.

5. The emergency call capable system of claim 2, wherein passing the human voice test requires identification of at least one of:
a human voice saying at least one predefined keyword;
a human voice saying a predefined phrase.

6. The emergency call capable system claim 1, wherein the remote system is a monitoring station configured to monitor a plurality of emergency call capable systems.

7. The emergency call capable system claim 1, wherein the call and the further call is over a Public Switched Telephone Network (PSTN), wherein the communications apparatus comprises a PSTN modem.

8. The emergency call capable system of claim 1, wherein the occurrence of a trigger event is determined based on a signal received from at least one device selected from a group consisting of: a motion sensor; a camera; a health and/or care monitoring device; a fall detector; and/or a distress device.

9. The emergency call capable system of claim 8 comprising a control hub configured to wirelessly communicate with one or more devices, the one or more devices comprising said at least one device.

10. The emergency call capable system of claim 9, comprising at least one voice-extender module communicably coupled to the control hub, the at least one voice-extender module comprising digital signal processing circuitry configured to execute at least one voice recognition algorithm for identifying a distress sound, word or phrase voiced by a person, and based on an identification of the distress sound, word or phrase send a signal to the control hub to indicate occurrence of the trigger event.

11. The emergency call capable system of claim 1, wherein the system comprises a Personal Emergency Response System (PERS) device.

12. The emergency call capable system of claim 1, wherein in response to the trigger event the processing means is further configured to instruct a communications apparatus to transmit a notification of the trigger event to an application server associated with the remote system, wherein initiating the call to a remote system comprises transmitting, to a network, instructions to connect the emergency call capable system to a phone number associated with the remote system.

13. The emergency call capable system of claim 12, wherein transmitting the notification of the trigger event comprises initiating a first call to the remote system by transmitting signals over a phone line established by the first call.

14. The emergency call capable system of claim 13, wherein said call is said first call.

15. The emergency call capable system of claim 13, wherein said first call precedes said call, and initiating said call is in response to the emergency call capable system receiving signals from the remote system indicating acceptance, by the remote system, of the notification.

16. The emergency call capable system of claim 1, wherein in response to the trigger event the processing means is further configured to instruct a communications apparatus to transmit a notification of the trigger event to an application server associated with the remote system, wherein initiating the call to a remote system comprises transmitting, to a network, instructions to connect the emergency call capable system to a phone number associated with the remote system, wherein the notification comprises a network address of the application server.

17. The emergency call capable system of claim 1, wherein said call and said further call are to the same phone number.

18. The emergency call capable system of claim 1, wherein said call and said further call are to different respective phone numbers.

19. The emergency call capable system of claim 1, wherein the condition comprises that the call passes the call duration test.

20. The emergency call capable system of claim 19, wherein the processing means is configured to determine the whether the call has a duration lasting at least as long as a predefined minimum and in an event that the duration is determine to last at least as long as the predefined minimum, determine that the call duration test is passed.

21. The emergency call capable system of claim 1, wherein the call is commenced upon completion of transmitting, to a network, instructions to connect the emergency call capable system to a phone number associated with the remote system.

22. The emergency call capable system of claim 1, wherein the processing means is further configured to determine that, upon receiving a signal indicative of completion of the call, the call has been ended; for example, wherein the signal indicative of completion of the call comprises a DTMF tone or a line-busy signal.

23. A computer-implemented method of operating an emergency call capable system, the method comprising:
instructing a communications apparatus to initiate a call to a remote system in response to a trigger event;
determining whether the call satisfies a condition comprising at least one of:
(a) the call passes a call duration test, wherein the condition further comprises a sub-condition that the call is determined to have been connected for at least a minimum period of time; and
(b) that data transferred from the remote system after initiating the call passes a human voice test, wherein the data passing the human voice test requires that at least some of the data defines a human voice; and
instructing the communications apparatus to initiate a further call to the remote system in response to failing to satisfy the condition.

24. A computer program product comprising instructions which, when the program is executed by a computer, cause the computer to carry out the method of claim 23.
